(19) United States
(12) Patent Application Publication
(10) Pub. No.: US 2005/0281648 A1
(43) Pub. Date: Dec. 22, 2005

(54) Animal feeder raising & lowering apparatus

(76) Inventors: Donald E. Hockenyos, Arcadia, LA (US); Robert W. Cedolal, Simmsboro, LA (US)

Correspondence Address: John M. Harrison, 2139 E. Bert Kouns, Shreveport, LA, 71105, US

(21) Appl. No.: 11/119,989

(22) Filed: May 2, 2005

Related U.S. Application Data
(60) Provisional application No. 60/568,166, filed on May 6, 2004.

(51) Int. Cl. B60P 9/00

(52) U.S. Cl. 414/462

(57) ABSTRACT

An animal feeder raising and lowering apparatus characterized in a preferred embodiment by an elongated boom pivotally and removably supported by a pair of support legs extending from a support base and having a bifurcated feeder mount mounted on the upper end for removably carrying an animal feeder and a counterweight or counterweight container attached to the bottom end of the boom. In another preferred embodiment a boom stabilizer is upward-standing from the support base and is spaced-apart from the support legs for supporting and stabilizing the boom when the boom is pivoted into the horizontal position, to facilitate loading and/or unloading the feeder. A winch may be secured to the boom stabilizer with the winch line extending to the boom for pivoting the boom on the support legs. In yet another preferred embodiment the feeder is removably secured to the bifurcated feeder mount by means of slots provided in the feeder mount and cradle pins extending from the slots to a cradle carrying the feeder. The boom is typically pivotally and removably attached to the upward-standing boom support legs by means of a boom pin or pins extending through companion slots provided in each of the boom support legs.

### CROSS-REFERENCE TO RELATED APPLICATIONS

This application claims the benefit of and incorporates by reference prior filed copending U.S. Provisional Application Ser. No. 60/568,166, Filed May 6, 2004.

### SUMMARY OF THE INVENTION

This invention relates to devices and mechanisms for raising and lowering animal feeding equipment and more particularly, to an animal feeder raising and lowering apparatus characterized by a pivoting boom having a counterbalancing counterweight or counterweight container at the bottom end and typically using a winch apparatus for pivoting the boom and raising and lowering an animal feeder at the opposite end of the boom. In a preferred embodiment the animal feeder raising and lowering apparatus includes an elongated boom pivotally attached to a pair of upward-standing support legs by means of a boom pin or pins extending through or to the boom and through notches or slots in the support legs, to facilitate removably and pivotally mounting the boom or receptacle on the support legs. A counterbalancing counterweight or counterweight container is typically pivotally mounted or fixed to the bottom end of the boom to offset the weight of an animal feeder pivotally attached to the upper end of a bifurcated feeder mount, the bottom end or spacer of which feeder mount is attached to the upper end of the boom. In a preferred embodiment parallel upper arms extending from the spacer element of the bifurcated feeder mount, which is typically removably attached to the boom, are slotted or notched to facilitate removably receiving a pair of cradle pins extending to a cradle attached to the feeder, thus allowing the feeder to be selectively removed from and mounted on the bifurcated feeder mount. Keeper shoulders may be defined by curved slots provided in the support legs and in the arms of the bifurcated feeder mount to removably, yet securely, engage the boom pin or pins and the cradle pins, respectively, and facilitate easy disassembly and storage, as well as shipping, of the apparatus.

In another preferred embodiment of the invention a typically bolted-together angle-iron support base is provided on the ground and supports the spaced-apart, typically angled and notched or slotted boom support legs and a boom stabilizer projects upwardly from bolted attachment to the support base and is spaced-apart from the boom support legs and typically braced to the boom support legs for receiving the boom when the boom is pivoted into the horizontal configuration, to facilitate access to the feeder pivotally attached to the upper end of the bifurcated feeder mount. A winch is typically bolted or otherwise secured to the boom stabilizer and the winch line extends to the boom, where it is attached. Accordingly, the feeder can be raised and lowered by operating the winch and pivoting the elongated boom on the boom pin or pins with respect to the fixed boom support legs and the boom stabilizer to access the feeder for selectively loading and dispensing animal feed. When the feeder is in the raised or elevated position, it is typically located directly above and in alignment with the boom support legs and the boom, between the respective parallel and spaced-apart feeder mount arms, and the counterweight or counterweight container is positioned directly beneath the boom pin or pins, between the angled boom support legs.

### BRIEF DESCRIPTION OF THE DRAWINGS

The invention will be better understood by reference to the accompanying drawings, wherein:

FIG. 1 is a side elevation of a first embodiment of the animal feeder raising and lowering apparatus with the feeder in partially elevated configuration;

FIG. 2 is a side elevation of the animal feeder raising and lowering apparatus illustrated in FIG. 1, with the animal feeder eliminated, for brevity;

FIG. 3 is a front elevation of the animal feeder raising and lowering apparatus illustrated in FIG. 1, with the animal feeder fully elevated;

FIG. 4 is a side elevation of a second embodiment of the animal feeder raising and lowering apparatus, more particularly illustrating the use of curved slots for receiving corresponding pins and supporting the boom, feeder and counterweight elements of the apparatus;

FIG. 5 is a front elevation of the animal feeder raising and lowering apparatus illustrated in FIG. 4, with the animal feeder fully elevated;

FIG. 6 is a side view, partially in section, of the upper end of a typical feeder mount arm element of the animal feeder raising and lowering apparatus illustrated in FIGS. 4 and 5;

FIG. 7 is a side view of the entire feeder mount arm element illustrated in FIGS. 4 and 6;

FIG. 8 is a side view of the feeder mount arm element illustrated in FIG. 7;

FIG. 9 is a side view, partially in section, of the top end of a typical boom support leg element of the animal feeder raising and lowering apparatus illustrated in FIGS. 4 and 5;

FIG. 10 is a side view of an entire boom support leg illustrated in FIGS. 4 and 5;

FIG. 11 is a side view of the boom support leg illustrated in FIG. 10;

FIG. 12 is a side view of a typical counterweight mount element of the animal feeder raising and lowering apparatus illustrated in FIGS. 4 and 5;

FIG. 13 is a front view of the counterweight mount element illustrated in FIG. 12;

FIG. 14 is a front view of a typical gusset used to span and support the respective boom support legs illustrated in FIG. 5;

FIG. 15 is a front view of a typical leg brace used to further support and strengthen the boom support legs illustrated in FIGS. 4 and 5;

FIG. 16 is an end view of the leg brace illustrated in FIG. 15;

FIG. 17 is a front view of a typical stabilizing brace used to span distance between the boom stabilizer and the boom support legs illustrated in FIGS. 4 and 5;

FIG. 18 is a top view of the stabilizer brace illustrated in FIG. 17.

FIG. 19 is a side view of another embodiment of the animal feeder raising and lowering apparatus, with a weight container or receptacle bolted to the boom; and

FIG. 20 is a rear elevation of the animal feeder raising and lowering apparatus illustrated in FIG. 19.

### DESCRIPTION OF THE PREFERRED EMBODIMENTS

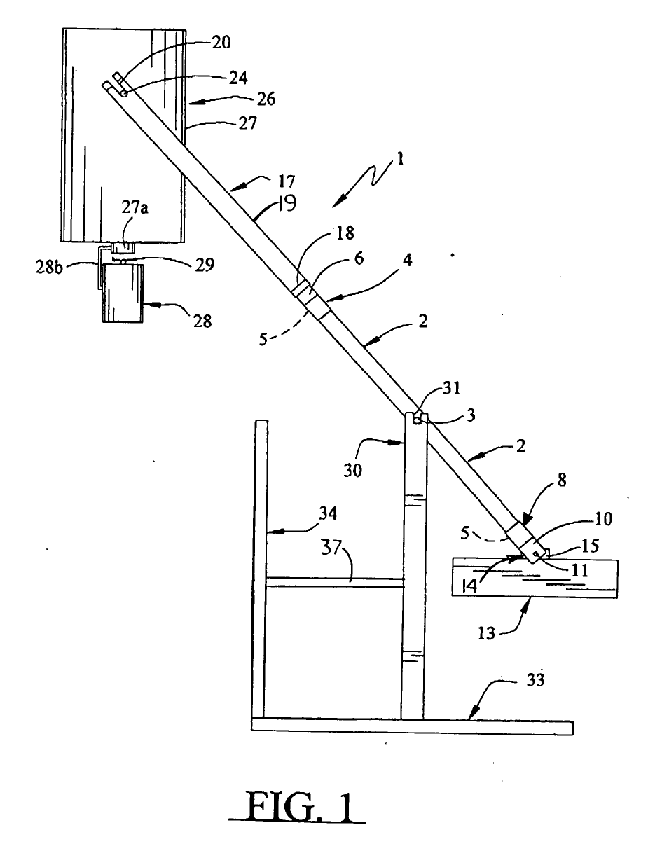

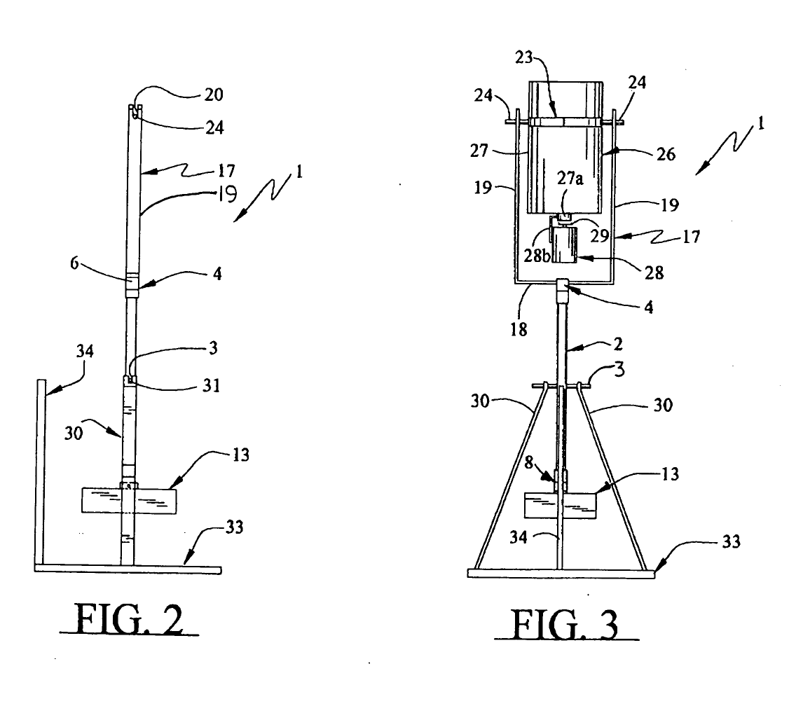

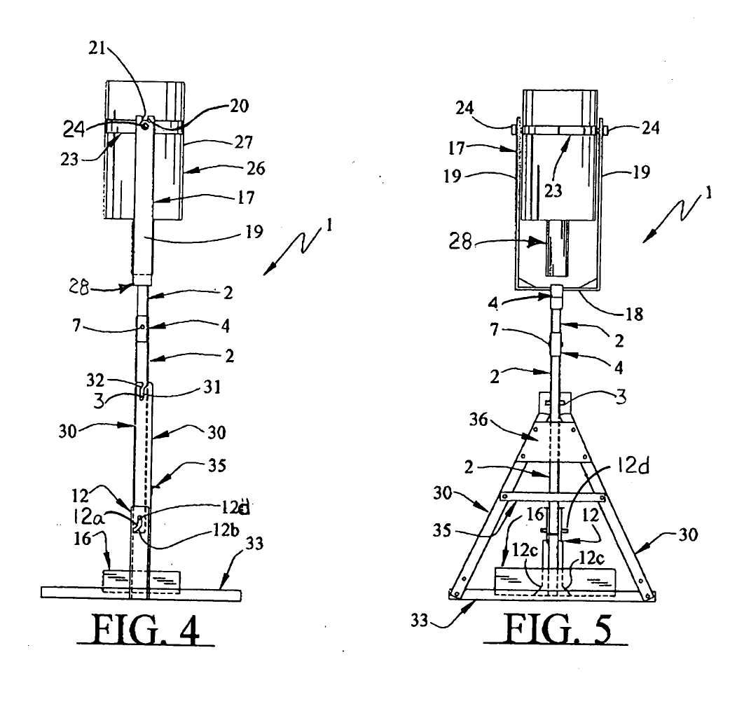

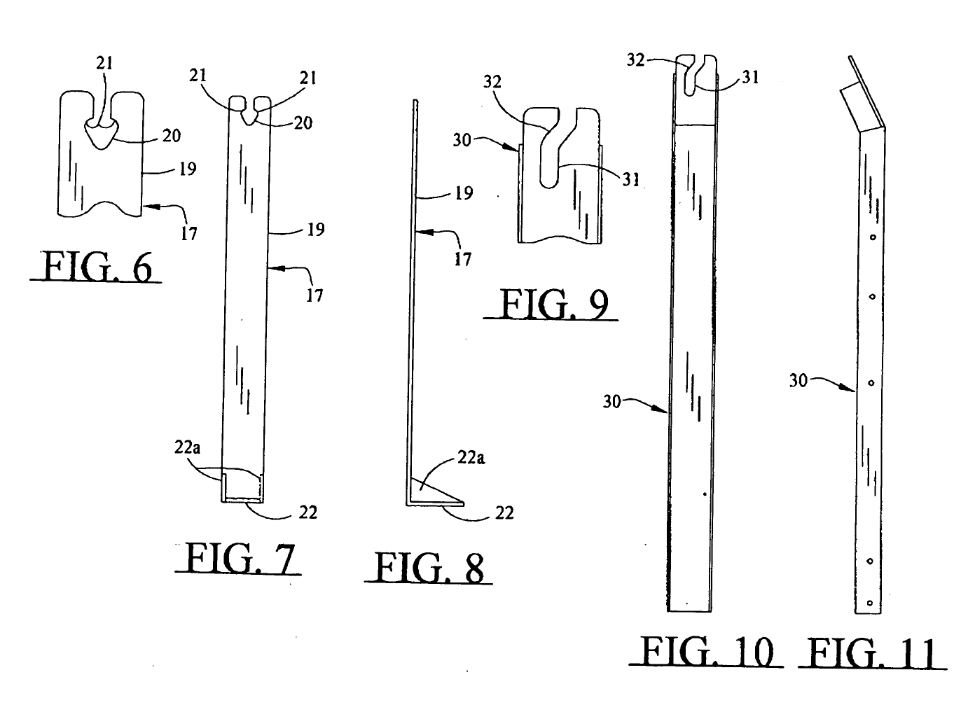

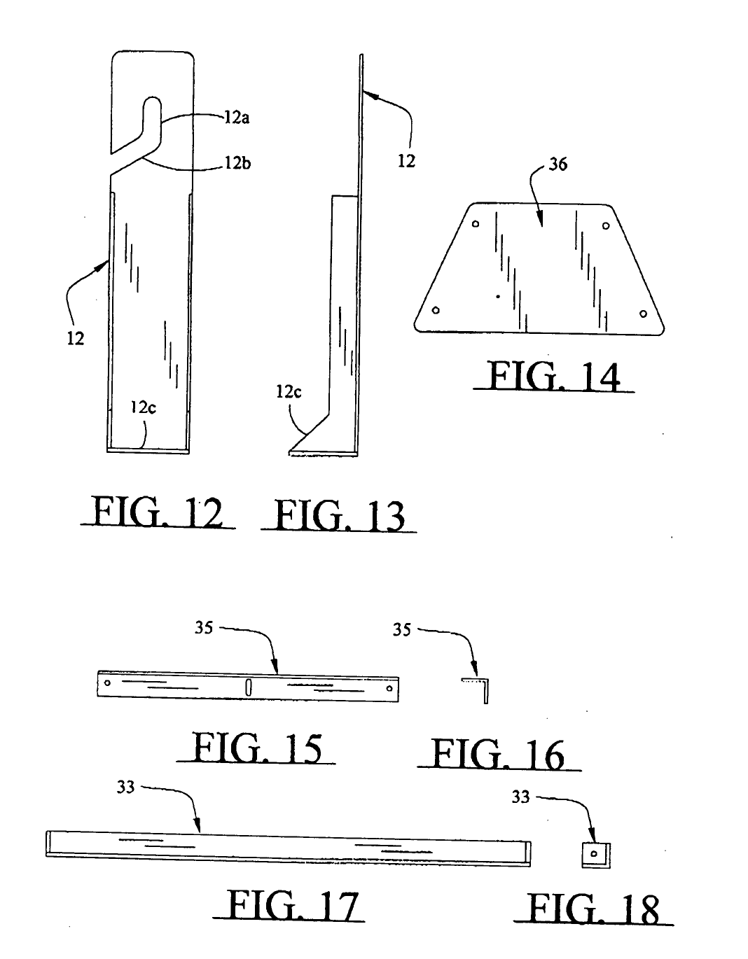

Referring initially to FIGS. 1-3 of the drawings in a first embodiment the animal feeder raising and lowering apparatus of this invention is generally illustrated by reference numeral 1. The animal feeder raising and lowering apparatus 1 is easily assembled and disassembled and is characterized by an elongated boom 2 of selected material and length, typically fitted with a single boom pin 3, usually located in the approximate center thereof, and having a feeder mount connector 4 attached to the top end and a counterweight connector 8 secured to the bottom end thereof, typically by means of connector threads 5. The feeder mount connector 4 is shaped to define a connector end 6 that is welded or otherwise secured (optionally, by a connector pin 7, FIGS. 4 and 5), to the feeder mount spacer 18 of a bifurcated feeder mount 17. The bifurcated feeder mount 17 is further characterized by upward-standing, parallel and spaced-apart feeder mount arms 19 (FIG. 3), projecting from the opposite ends of the feeder mount spacer 18 and each typically having arm mount flanges 22 and flange gussets 22a, (FIGS. 7 and 8) and an arm notch 20 (FIGS. 1 and 2) or a curved slot 20, the latter having a keeper shoulder 21 shaped therein in the extending end thereof, as further illustrated in FIGS. 4, 6 and 7, in a second embodiment of the invention. The arm slot keeper shoulder 21 is typically shaped in the arm slot 20 in each of the extending ends of the feeder mount arms 19 in this embodiment (FIG. 7) to securely, yet removably, receive the extending ends of a pair of linearly aligned cradle pins 24, projecting from opposite sides of a feeder band or cradle 23, as further illustrated in FIG. 4. In both embodiments the cradle pins 24 project in oppositely-disposed, 180-degree relationship from a feeder 26 (FIG. 1) or from a feeder cradle 23, which mounts the feeder 26, (FIGS. 3-5) containing typically pelletized or particulate animal feed (not illustrated). The feed is disposed for dispersal by gravity through a bottom-located opening (not illustrated), to a feed broadcaster 28, which is detailed in FIGS. 1 and 3 and generically illustrated in FIGS. 4 and 5. In both embodiments the feeder 26 is typically characterized by a cylindrical feeder drum 27, typically carrying the feed broadcaster 28 by means of a broadcaster mount 28b, in order to dispense particulate feed loaded inside the feeder drum 27, through a feed opening (not illustrated) in a drum spout 27a, extending from the bottom of the feeder drum 27, to the feed broadcaster 28 and from there, to the ground below.

In the first embodiment illustrated in FIGS. 1-3, the bottom end of the boom 2, which is typically threadably secured to the counterweight connector 8, receives a counterweight 13 of any suitable material and design, typically fitted with a counterweight bracket 14 having counterweight bracket legs 15. In this embodiment the counterweight bracket legs 15 are secured to a pair of bifurcated legs 10 in a connector bifurcation extending from the counterweight connector 8, by means of a leg pin 11, as further illustrated in FIG. 1 of the drawings. This arrangement facilitates pivotal attachment of the counterweight 13 to the bottom end of the boom 2.

In a second embodiment illustrated in FIGS. 4-18, the counterweight device is characterized by a counterweight tray 16 having a pair of upward-standing, parallel counterweight mounts 12, each fitted with a mount foot 12c, for bolting to the counterweight tray 16, and provided with curved mount slots 12a, having a mount slot shoulder 12b therein (FIG. 12). The counterweight mounts 12 are removably suspended from a mount pin or pins 12d provided in the boom 2, as illustrated in FIGS. 4 and 5.

In a third and most preferred embodiment of the invention the boom stabilizer 34 is fitted with a winch 41, having a winch line 42 that connects to the boom 2 above the boom pin 3, for pivoting the boom 2 on the boom pin 3 to raise and lower the feeder 26. A counterweight container 40 is also fixed to the boom 2 for receiving a selected number of weights (not illustrated) and includes a removable container lid 40.

As further illustrated in FIG. 5 of the drawings a pair of boom support legs 30 typically angle inwardly from bolted attachment to a support base 33 and upwardly toward the boom 2 and are each typically fitted with curved leg notches or slots 31 (FIG. 4) on the extending end thereof. The leg slots 31 may be curved to define leg slot keeper shoulders 32, respectively, (FIG. 10) for receiving and securing one end of a boom pin or pins 3 that extend through or from each side the boom 2. Accordingly, it will be appreciated from a consideration of FIGS. 1, 2, 4 and 5 of the drawings that in the first two embodiments of the invention the boom 2, as well as the bifurcated feeder mount 17 and the feeder 26 on the upper end of the boom 2 and the counterweight 13 and counterweight tray 16, respectively, are typically removably and pivotally fitted to the bottom end of the boom 2 and are supported by the pair of boom support legs 30 above the support base 33. Furthermore, in the second and third embodiments illustrated in FIGS. 4-18 and 19 and 20 of the drawings, which include the counterweight tray 16 and the counterweight container 39, respectively, the angled boom support legs 30, a leg brace 35 and a leg gusset 36 are added for additional boom and feeder support strength.

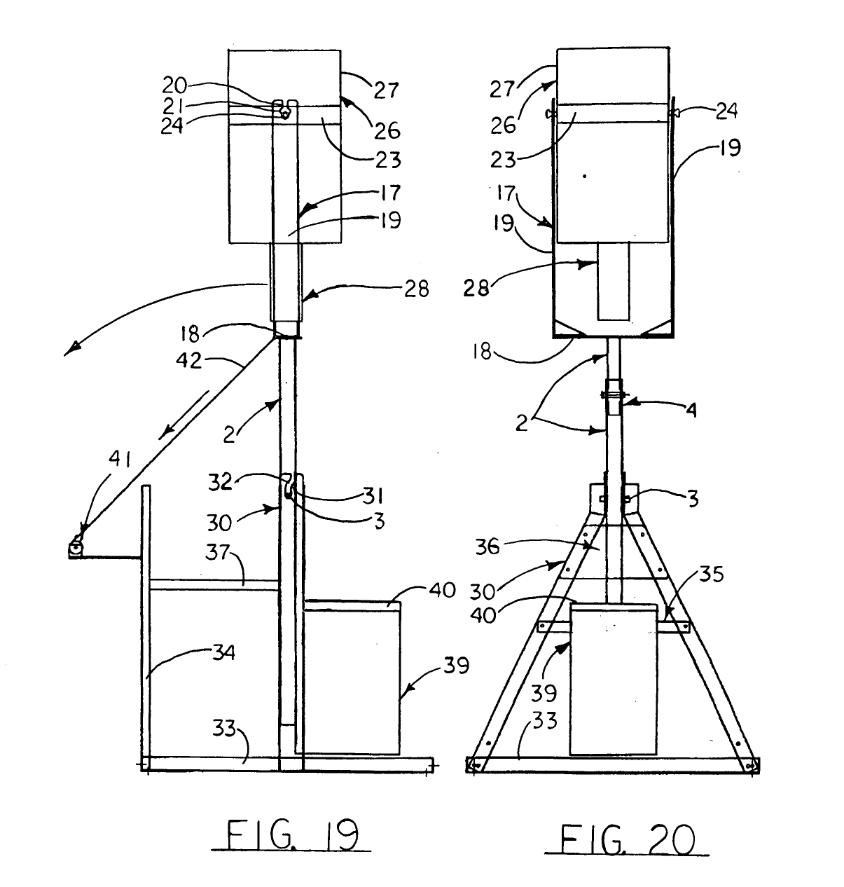

In a most preferred design of all embodiments of the invention a boom stabilizer 34 extends upwardly, typically from bolted attachment to the support base 33 and spaced-apart from the support legs 30, in a substantially vertical configuration as illustrated in FIG. 1 and is designed to receive, support and stabilize the boom 2 under circumstances where the boom 2 is pivoted into the horizontal configuration. The boom stabilizer 34 is typically constructed of angle iron and is preferably bolted to the leg brace 35 by means of a stabilizer brace 37 and serves to stabilize and support the boom 2, as well as the feeder 26, to facilitate loading and unloading the feeder 26 by pouring granular particulate or pelletized feed such as corn or the like, in the open top of the feeder drum 27 or removing it, in conventional fashion. The winch 41 (FIG. 19) is typically bolted or otherwise attached to the boom stabilizer 34 and the winch line 42 is secured in any convenient manner to the boom 2 above the boom pin 3, as illustrated. After the feed is loaded in the feeder 26, the boom 2 is easily manually pivoted to the upward vertical configuration illustrated in FIG. 2-5 by release-operation of the winch 41, wherein the counterweight 13, or the counterweight tray 16 or counterweight container 39, provided with a sufficient removable weight or weights (not illustrated) of any desired choice, serves as a counterbalance to minimize the effort necessary to pivot the boom 2, as well as the bifurcated feeder mount 17 and the feeder 26, back into the horizontal position using the winch 41. The feed broadcaster 28 can be activated by an internal timer or manually, to rotate the spinner 29 and broadcast the pelletized feed falling from the drum spout 27a of the feed drum 27, to the ground below when the device is disposed in the upright, functional configuration.

It will be appreciated by those skilled in the art that the animal feeder raising and lowering apparatus 1 of this invention in all embodiments, is characterized by optimum ease and convenience in assembly and disassembly, as well as positioning to the dispensing configuration and lowering to the loading configuration, as described above, due to the removability and position of the counterweight 13, the counterweight tray 16 or the fixed counterweight container 39, as well as the location of the boom stabilizer 34, respectively. Furthermore, the preferred pivoting function of the feeder 26 at the cradle pins 24 and the boom 2 at the boom pin 3, as well as the counterweight 13 at the leg pin 11 and the counterweight tray 16 at the mount pin 12d, respectively facilitates optimum positioning of the feeder 26, the boom 2 and the counterweight 13 and counterweight tray 16, as well as the fixed counterweight container 39, respectively, in the desired configuration for both loading and manipulating the feeder 26 into a desired dispensing configuration. In this regard, it will be appreciated by those skilled in the art that the boom 2 can be positioned in any desired angular configuration with respect to the boom support legs 30 and the boom stabilizer 34 in the embodiments described above, by simply interrupting rotation of the boom 2 on the boom pin 3, since there may be provided in the boom pin 3 and leg slot 31 connection sufficient friction and proper matching of the respective weights of the feeder 26 and the counterweight 13, as well as the individual weight or weights (not illustrated) in the counterweight tray 16 or the counterweight container 39, to enable this option.

It will also be appreciated that a feeder 26 of substantially any design may be utilized in the invention and may be mounted, typically, but not necessarily, using the feeder cradle 23 and the cradle pins 24 to the extending feeder mount arms 19 of the feeder mount 17, as illustrated in the drawings. Moreover, a counterweight 13, counterweight tray 16 or counterweight container 39 of substantially any design and weight may also be utilized; for example, concrete, steel or the like can be used to construct the counterweight 13, and pivotal attachment of the counterweight 13 and the counterweight tray 16 to the bottom end of the boom 2, respectively, facilitates a smooth, pivoting function at the boom pin 3 to facilitate maneuvering and manipulation of the feeder 26 into the desired configuration extending from the top of the boom stabilizer 34 at the bottom-most position, to the vertical configuration, as illustrated in FIGS. 3-5. Furthermore, the boom element of the apparatus can be locked or otherwise secured to the legs to prevent unauthorized access to the feeder, as desired.

While the preferred embodiments of the invention have been described above, it will be recognized and understood that various modifications may be made in the invention and the appended claims are intended to cover all such modifications which may fall within the spirit and scope of the invention.

1. An animal feeder raising and lowering apparatus comprising a support; a boom pivotally carried by said support; an animal feeder pivotally carried by one end of said boom; and a counterweight carried by the opposite end of said boom from said one end, wherein said animal feeder is selectively pivoted into an elevated position above said support and into a loading position spaced from said support, responsive to pivoting of said boom on said support.

2. The animal feeder raising and lowering apparatus of claim 1 wherein said support comprises at least one pair of spaced-apart support legs and at least one boom pin carried by said boom, said boom pin engaging said support legs for pivotally supporting said boom on said support legs.

3. The animal feeder raising and lowering apparatus of claim 1 comprising a winch spaced-apart from said support and a winch line extending from said winch and connected to said boom for pivoting said boom on said support.

4. The animal feeder raising and lowering apparatus of claim 1 wherein said counterweight comprises a counterweight container carried by said opposite end of said boom for receiving at least one weight, said counterweight container and said weight being substantially equal to the weight of said animal feeder.

5. The animal feeder raising and lowering apparatus of claim 4 comprising a support base for receiving and supporting said support.

6. The animal feeder raising and lowering apparatus of claim 5 wherein said support comprises a pair of spaced-apart support legs extending from said support base; a support notch or slot provided in each of said support legs; and a boom pin carried by said boom, said boom pin engaging said support notch or slot in said support legs for pivotally and removably supporting said boom on said support legs, and comprising a winch spaced-apart from said support legs and a winch line extending from said winch and connected to said boom for pivoting said boom on said support.

7. The animal feeder raising and lowering apparatus of claim 1 comprising a bifurcated feeder mount provided on said one end of said boom and at least one feeder pin extending from said animal feeder and pivotally engaging said bifurcated feeder mount, for pivotally supporting said animal feeder in said bifurcated feeder mount.

8. The animal feeder raising and lowering apparatus of claim 7 comprising a pair of mount notches or slots provided in said bifurcated feeder mount for removably receiving said feeder pin.

9. The animal feeder raising and lowering apparatus of claim 7 comprising a winch spaced-apart from said support and a winch line extending from said winch and connected to said boom for pivoting said boom on said support.

10. The animal feeder raising and lowering apparatus of claim 9 wherein said support comprises at least one pair of spaced-apart support legs and comprising a boom pin carried by said boom, said boom pin engaging said support legs for pivotally supporting said boom on said support legs and said counterweight comprises a counterweight container carried by said opposite end of said boom for receiving at least one weight, said counterweight container and said weight being substantially equal to the weight of said animal feeder.

11. The animal feeder raising and lowering apparatus of claim 10 comprising:
(a) a curved support notch or slot provided in each of said support legs for removably and pivotally receiving said boom pin; and
(b) a pair of curved mount notches or slots provided in said bifurcated feeder mount for removably and pivotally receiving said feeder pin.

12. The animal feeder raising and lowering apparatus of claim 11 comprising:
(a) a support slot keeper shoulder provided in each of said curved support notch or slot for removably retaining said boom pin in said curved support notch or slot; and
(b) a pair of arm slot keeper shoulders provided in said curved mount notches or slots for retaining said feeder pin in said curved mount notches or slots.

13. The animal feeder raising and lowering apparatus of claim 12 comprising a support base for receiving and removably supporting said support legs in spaced-apart relationship with respect to each other.

14. The animal feeder raising and lowering apparatus of claim 1 comprising an upward-standing boom stabilizer spaced-apart from said support for receiving and stabilizing said boom when said boom is pivoted with said animal feeder into said loading position.

15. The animal feeder raising and lowering apparatus of claim 14 comprising a winch spaced-apart from said support and a winch line extending from said winch and connected to said boom for pivoting said boom on said support and wherein said support comprises a pair of spaced-apart support legs and at least one boom pin carried by said boom, said boom pin removably and pivotally engaging said support legs for pivotally and removably supporting said boom on said support legs.

16. The animal feeder raising and lowering apparatus of claim 15 comprising a bifurcated feeder mount removably provided on said one end of said boom, a cradle mounted on said feeder and a pair of cradle pins extending from said cradle for pivotally and removably engaging said bifurcated feeder mount and pivotally and removably supporting said animal feeder in said bifurcated feeder mount.

17. The animal feeder raising and lowering apparatus of claim 16 wherein said counterweight comprises a counterweight container and removably carried by said opposite end of said boom for receiving at least one weight, said counterweight container and said weight being substantially equal to the weight of said animal feeder.

18. The animal feeder raising and lowering apparatus of claim 17 comprising:
(a) a curved support notch or slot provided in the top ends of each of said support legs for pivotally and removably receiving said boom pin;
(b) a pair of curved mount notches or slots provided in said bifurcated feeder mount for pivotally and removably receiving said cradle pin; and
(c) a removable lid provided on said counterweight container for selectively covering the weight in said counterweight container.

19. An animal feeder raising and lowering apparatus comprising a support; an elongated boom pivotally and removably carried by said support; an animal feeder pivotally and removably carried by one end of said boom; a counterweight container removably carried by the opposite end of said boom from said one end for receiving at least one weight and a winch spaced-apart from said support and a winch line extending from said winch and connected to said boom for pivoting said boom on said support, wherein said animal feeder is optionally pivoted into an elevated position above said support and into a loading position, responsive to operation of said winch and pivoting of said boom on said support and pivoting of said animal feeder and said counterweight container on said boom.

20. An animal feeder raising and lowering apparatus comprising a support; an elongated boom pivotally and removably carried by said support; an animal feeder pivotally and removably carried by one end of said boom; a counterweight container removably carried by the opposite end of said boom from said one end for receiving at least one weight; an upward-standing boom stabilizer spaced-apart from said support for receiving and stabilizing said boom; and a winch mounted on said stabilizing boom and a winch line extending from said winch and connected to said boom, wherein said animal feeder is optionally pivoted into an elevated position above said support and into a loading position spaced from said support and resting on said boom stabilizer responsive to operation of said winch and pivoting of said boom on said support.
